(19) United States
(12) Patent Application Publication
(10) Pub. No.: US 2010/0013825 A1
(43) Pub. Date: Jan. 21, 2010

(54) DISPLAY DEVICE AND METHOD FOR DRIVING THE DISPLAY DEVICE

(75) Inventors: Hiroyuki Takahashi, Yonezawa-shi (JP); Satoshi Kishida, Yonezawa-shi (JP); Yoshimasa Kaneko, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: PIONEER CORPORATION, Tokyo (JP); TOHOKU PIONEER CORPORATION, Tendo, Yamagata (JP)

(21) Appl. No.: 12/528,276

(22) PCT Filed: Mar. 14, 2007
(86) PCT No.: PCT/JP2007/055026

§ 371 Date: Aug. 21, 2009

(51) Int. Cl. G09G 5/00; G09G 3/30

(52) U.S. Cl. 345/214; 345/76

(57) ABSTRACT

This invention provides a display device constituted of a display panel in which pixels including light-emitting elements E11 to Emn are connected in the form of a matrix at each intersection between a plurality of data lines A1 to Am and a plurality of scan lines K1 to Kn, a scan driver connected to the scan lines and selectively scanning each of the scan lines, and a data driver supplying a display signal to each of the pixels.

Timings of charging and discharging a charge, charged and discharged in a parasitic capacitance of each of the light emitting elements, are dispersed, and a level of radiation noise generated at this time can be reduced.

### BACKGROUND OF THE INVENTION

1. Field of the Invention

The present invention relates to a display device, which uses as a display pixel a capacitive element such as an organic EL (electroluminescence) element, and a method for driving the display device.

2. Description of the Related Art

A widespread use of a portable telephone and a personal digital assistance (PDA) increases the demand for a display panel which has a high-definition image display function and can realize the reduction in thickness and the reduction of the power consumption. In the prior art, a liquid crystal display panel as a display panel satisfying the demand has been used in many products.

In these latter days, an organic EL element utilizing such characteristics as being a self-light-emitting element is in practical use and has attracted attention as the next generation of display panel to replace the prior art liquid crystal display panel. This is because there is a background that a promising organic compound which could realize the good emission property is used in an emission layer of the element, whereby the organic EL element having a higher efficiency and a longer life enough to withstand practical use is realized.

The organic EL element is basically constituted of a transparent electrode (anode electrode) and a light-emitting functional layer, which are formed of, for example, ITO, and a metal electrode (cathode electrode) formed of, for example, aluminum alloy, these layers being sequentially stacked on a transparent substrate such as glass.

The light-emitting functional layer may have a single light-emitting layer formed of an organic compound, have a bilayer structure including an organic hole transport layer and a light-emitting layer, have a trilaminar structure including an organic hole transport layer, a light-emitting layer, and an organic electron transport layer, or have a multilayer structure including a hole injection layer inserted between the transparent electrode and a hole transport layer and an electron injection layer inserted between the metal electrode and an electron transport layer. The light generated in the light-emitting functional layer is derived outside through the transparent electrode and the transparent substrate.

The organic El element may have a composition comprising a light-emitting element electrically having a diode characteristic and a parasitic capacitance component binding in parallel to the light-emitting element, and thus, the organic EL element can be said to be a capacitive light-emitting element. When the organic EL element is subjected to a light-emitting drive voltage, a charge which corresponds to the electrical capacitance of the organic EL element and is a displacement current is first flown into an electrode to be accumulated. Subsequently, when a certain voltage inherent in the organic EL element (a light-emitting threshold voltage=Vth) is exceeded, it can be considered that a current is started to be flown from one electrode (anode side of the diode component) to the light-emitting functional layer, and light emission occurs with an intensity proportional to the current.

Meanwhile, the organic EL element is generally driven by a constant current due to such reasons that while the current-luminance characteristic of the organic EL element is stable to temperature changes, the voltage-luminance characteristic of the organic EL element highly depends on temperature and that the organic EL element is considerably deteriorated when subjected to excess current to reduce the emission lifetime. As a display panel using the organic EL element, a passive drive display panel in which elements are arranged in the form of a matrix has already been practically used in part.

FIG. 1 shows an example of the prior art passive matrix display panel and its drive circuit, and a configuration of a cathode line scan/anode line drive is shown. More specifically, m data lines (hereinafter referred to also as anode lines) A1-Am are arranged in a longitudinal direction, and n scan lines (hereinafter referred to also as cathode lines) K1-Kn are arranged in a lateral direction. Organic EL elements E11-Emn indicated by parallel couplings represented by the symbol marks of diodes and capacitors are arranged at intersections (total of m×n points) between the anode lines and the cathode lines, whereby a display panel 1 is constituted.

The EL elements E11 to Emn constituting a pixel correspond to each intersection between the anode lines A1 to Am in the longitudinal direction and the cathode lines K1 to Kn in the lateral direction, and while one ends (anode terminals in equivalent diodes of the EL elements) are connected to the anode lines, the other ends (cathode terminals in the equivalent diodes of the EL elements) are connected to the cathode lines. Further, the anode lines A1-Am are respectively connected to an anode line drive circuit 2, which is used as a data driver, to be driven, and the cathode lines K1-Kn are respectively connected to a cathode line scan circuit 3, which is used as a scan driver, to be driven.

The anode line drive circuit 2 is provided with constant current sources I1 to Im and drive switches Sa1 to Sam operated by utilizing a supply voltage from a drive voltage source VH. The drive switches Sa to Sam are connected to the sides of the constant current sources I1 to Im, whereby currents from the constant current sources I1 to Im are supplied to the individual EL elements E11 to Emn arranged so as to correspond to the cathode lines. The drive switches Sa1 to Sam are constituted so that when the current from the constant current sources I1 to Im is not supplied to the individual EL elements, the anode lines can be connected to a ground side as a reference potential point of a circuit.

Meanwhile, the cathode line scan circuit 3 serving as a scan driver is provided with scan switches Sk1 to Skn respectively corresponding to the cathode lines K1 to Kn and is constituted so that any one of a reverse bias voltage and a ground potential GND can be supplied to a corresponding cathode line. The reverse bias voltage serves as a non-scanning selection potential and is supplied from a reverse bias voltage source VM mainly used to prevent crosstalk emission. The ground potential GND serves as a scanning selection potential and is used as a reference potential point.

Control signals are respectively supplied from a light-emission control circuit 4, including, for example, a CPU, to the anode line drive circuit 2 and the cathode line scan circuit 3 through a control bus. Switching operations for the scan switches Sk1 to Skn and the drive switches Sa1 to Sam are performed based on a video signal to be displayed.

According to the above constitution, the constant current sources I1 to Im are connected to desired anode lines while the cathode lines are set at the ground potential in a predetermined period cycle based on the video signal, and the EL elements E11 to Emn selectively emit light. Thus, an image based on the video signal is displayed on the display panel 1 as if the image were continuously turned on.

In the state shown in FIG. 1, the second cathode line K2 is set at the ground voltage to be brought into a scan state, and at this time, the reverse bias voltages from the reverse bias voltage source VM are applied to the cathode lines K1 and K3 to Kn in a non-scan state. In this case, when the forward voltage of the EL element in a scan turned-on state is represented by Vf, each potential is set to satisfy a relationship given by: [(forward voltage Vf)−(reverse bias voltage VM)]<(light-emitting threshold voltage Vth), and thus the EL elements connected at the intersections between the driven anode lines and the cathode lines which are not selected for scanning are prevented from emitting cross talk light.

The organic EL elements arranged on the display panel 1 respectively have parasitic capacitances as described above, and these elements are arranged in the form of a matrix at the intersections between the anode lines and the cathode lines. Thus, for example, when several tens of EL elements are connected to one anode line, as viewed from this anode line, a synthesized capacitance of several hundred times or more the parasitic capacitance is connected as a load capacitance to the anode line. As the size of the matrix increases, the synthesized capacitance notably increases.

Thus, at the beginning of a turning-on period of the EL elements for each scanning, the currents from the constant current sources I1 to Im through the anode line are consumed to charge the synthesized load capacitance, and time delay occurs to charge the load capacity until the load capacity satisfactorily exceeds the light-emitting threshold voltage (Vth) of the EL elements. Therefore, there occurs a problem that rising of light emission of the EL elements is delayed (slowed). In particular, when the constant current sources I1 to Im are used as drive sources of the EL elements as described above, the currents are restricted because the constant current sources are high-impedance output circuits on an operational principle, whereby the rising of light emission of the EL elements is remarkably delayed.

This is causative of the reduction of the turned-on time rate of the EL elements, and therefore, there is a problem that the substantial light emission luminance of the EL elements is reduced. Thus, in order to eliminate the delay of the rising of light emission of the EL element due to the parasitic capacitance, in the configuration shown in FIG. 1, a reset operation is performed. In the reset operation, the parasitic capacitance of the EL element to be turned on is charged for each scanning period by utilizing the reverse bias voltage VM.

FIG. 2 shows the turned-on drive operation of the EL element including the reset operation and schematically shows a state of the current applied to each element with regard to the anode line A1. Namely, FIG. 2 shows from a turned-on state of the EL element E11 connected to the first cathode line (first scan line) K1 to a turned-on state of the EL element E12, connected to the second cathode line (second scan line) K2, after the reset operation.

As shown in FIG. 2A, when the EL element E11 is turned on, the cathode of the EL element E11 is set to ground through the first scan line K1, and a drive current from the constant current source I1 is supplied to the EL element E11. At this time, the reverse bias voltage VM is applied to other EL elements (represented by the symbol marks of capacitors) connected to the anode line A1.

The EL element E12 will be turned on in the next scanning; however, before the EL element E12 is turned on, the anode line A1 is connected to the ground potential through the switch Sa1 as shown in FIG. 2B, and all cathode lines are connected to the ground potential through the scan switches SK1 to SKn. According to this constitution, the reset operation is performed so that all charges accumulated in the parasitic capacitances of the respective EL elements are discharged.

Next, in order to turn on the EL element E12, the second scan line K2 is brought into a scan state. Namely, while the second scan line K2 is connected to ground, the other scan lines are subjected to the reverse bias voltage VM. At this time, the drive switch Sa1 is switched to the constant current source I1 side.

The charge of the parasitic capacitance in each element is discharged in the reset operation, and therefore, in this instant, as shown in FIG. 2C, the parasitic capacitances of the elements other than the EL element E12 to be turned on subsequently are charged by the reverse bias voltage VM applied in the opposite direction to the drive current from the constant current source I1, as shown by allows.

The charging current for these elements flows into the EL element E12, to be turned on subsequently, through the anode line A1 to instantly charge the parasitic capacitance of the EL element E12. At this time, the constant current source I1 connected to the anode line A1 is basically a high impedance circuit as described above and thus does not influence the movement of the charging current. Thereafter, the drive current supplied from the constant current source I1 to be applied to the anode line A1 causes the EL element E12 to be in the turned-on state as shown in FIG. 2D.

FIG. 3 is a timing chart for explaining the turned-on drive operation of the EL element performed for one scanning period and including the reset period. FIG. 3A shows a scan synchronization signal. The reset period and the turning-on period (constant current drive period=CC) are set in synchronism with the scan synchronization signal.

FIGS. 3B and 3C show electrical potentials applied to a turned-on line and a turned-off line in the anode lines connected to the data driver (anode line drive circuit) 2 in the respective periods. FIGS. 3D and 3E show electrical potentials applied to a non-scan line and a scan line in the cathode lines connected to the scan driver (cathode line scan circuit) 3 in the respective periods.

In the reset period shown in FIG. 3, the drive switches Sa1 to Sam provided in the data driver 2 set the anode line (turned-on line), corresponding to the EL element to be turned on and controlled, and the anode line (turned-off line), corresponding to the EL element to be turned off, to the ground potential GND as shown in FIGS. 3B and 3C.

Meanwhile, the scan driver 3 in the reset period sets the cathode line which is not scanned (non-scan line) and the cathode line to be scanned (scan line) to the ground potential GND as shown in FIGS. 3D and 3E by the scan switches Sk1 to Skn provided in it.

Therefore, the anode and cathode of all EL elements arranged on the display pane 1 are set at the ground potential GND, and the charges accumulated in the parasitic capacitances are zero reset (GND-GND reset), namely resulting in the state shown in FIG. 2B as described above.

In the subsequent constant current drive period that is the turning-on period of the EL element, the drive switches Sa1 to Sam supply constant currents from the constant current sources I1 to Im to the anode lines (turned-on lines) corresponding to the EL elements to be turned on as shown in FIG. 3B. The anode lines (turned-off lines) corresponding to the EL elements to be turned off is set at the ground potential GND as shown in FIG. 3C.

Meanwhile, the scan driver 3 in the turning-on period (constant current drive period) is controlled so that the scan switches Sk1 to Skn provided in the scan driver 3 apply the reverse bias voltage VM, which is a non-scan selection potential as shown in FIG. 3D, to the cathode lines which are not scanned (non-scan lines), and controlled so that the cathode lines to be scanned (scan lines) are set at the ground potential GND which is a scan selection potential as shown in FIG. 3E.

Therefore, immediately after the shift to the turning-on period (constant current drive period), as described based on FIG. 2C, currents from the reverse bias voltage source VM transitionally flow into the EL elements to be turned on through an unscanned EL element, and the parasitic capacitance of the EL element to be turned on is rapidly precharged, and the light emission of the EL element to be turned on can be quickly started.

As described above, Japanese Patent No. 3507239 filed by the present applicant discloses a passive drive display device, which precharges the EL element, which will be turned on and driven subsequently after the reset operation, utilizing the non-scan selection potential (reverse bias voltage).

In such a constitution that the reset operation is performed as disclosed in the Japanese Patent No. 3507239, the charges accumulated in the parasitic capacitances of all EL elements are instantly discharged at the start of the reset operation (discharge start timing a in FIG. 3), and therefore, radiation noise with a high level is generated.

In the termination of the reset operation (discharge termination timing b in FIG. 3), charging currents are supplied simultaneously to the elements to be turned on and driven (the elements are precharged) through the respective parasitic capacitances of the elements, which are subsequently determined not to be scanned. Therefore, also in this time, there occurs a problem that the radiation noise with a high level is generated.

Further, in the termination of the reset operation (the discharge termination timing b), a peak current for precharging instantly flows from the reverse bias voltage source VM through the scan lines which are not scanned, and therefore, a power supply voltage becomes unstable.

As described above, the radiation noise generated by the drive of the display device adversely affects peripheral circuits, and to make matters worse, the radiation noise renders the power supply voltage for driving the display device and each control signal unstable and is the main causative of the deterioration of display quality. The radiation noise generated accompanying the reset operation is more notably generated as the numbers of the scan lines and elements increase accompanying the size increase of the panel.

Thus, in order to reduce the radiation noise in the reset operation, Japanese Patent Application Laid-Open No. 2006-284828 discloses to shift the timing of supply of a driving signal to the data lines with respect to the timing of the termination of the reset operation (discharge termination timing).

FIG. 4 explains the operation shown in the Japanese Patent Application Laid-Open No. 2006-284828. FIGS. 4A to 4E respectively correspond to FIGS. 3A to 3E described above. According to the operation shown in this document, the timing of the supply of the driving signal of the constant current to the data lines (anode lines) to be turned on (timing c in FIG. 4) is shifted with respect to the termination of the reset operation (discharge termination timing b in FIG. 4).

In the invention disclosed in the Japanese Patent Application Laid-Open No. 2006-284828, the timing of the supply of the driving signal of the constant current to the data lines to be turned on (timing c) is shifted with respect to the termination of the reset operation (discharge termination timing b), as described above. However, in the start of the reset operation (timing a in FIG. 4) and in the termination of the reset operation (timing b in FIG. 4), discharging of the charge of the parasitic capacitances of the elements and charging of the parasitic capacitance of the element, which is turned on subsequently, through the respective elements are simultaneously performed.

Therefore, as with the prior art, the radiation noise is generated at the timings a and b in FIG. 4, whereby there occurs the above described problems including the adverse effect on the peripheral circuits. Further, at the timing b, as with the prior art, the current for charging instantly flows from the reverse bias voltage source VM through the scan lines which are not scanned. Thus, the invention disclosed in the Japanese Patent Application Laid-Open No. 2006-284828 cannot reduce the deterioration of the display quality caused by variation of the power supply voltage.

Thus, this invention focuses attention on the radiation noise generated in the start of the reset operation (discharge start timing) and in the termination of the reset operation (discharge termination timing), and an object of this invention is to provide a display device, which can effectively reduce the radiation noise, and a method for driving the display device. Another object of the present invention is to provide a display device, which can reduce such a phenomenon that in the termination of the reset operation, a current for charging instantly flows, whereby a power for driving of a display panel becomes unstable, and a method for driving the display device.

### SUMMARY OF THE INVENTION

A display device according to the present invention for solving the above problem is characterized by including at least the constitutions described below.

According to a first aspect of the invention, in the first preferred constitution, a display device includes a display panel in which pixels including a capacitive light-emitting element are arranged at each intersection between a plurality of data lines and a plurality of scan lines, a scan driver connected to the scan lines and selectively scanning each of the scan lines, and a data driver supplying a display signal to each of the pixels. In synchronism with the scanning performed by the scan driver, a reset period, in which a charge accumulated in each of the light-emitting elements is discharged, is set, and control is performed so that a discharge start timing in the reset period of the light-emitting elements connected to at least two of the scan lines is different.

According to a second aspect of the invention, in the second preferred constitution, a display device includes a display panel in which pixels including a capacitive light-emitting element are arranged at each intersection between a plurality of data lines and a plurality of scan lines, a scan driver connected to the scan lines and selectively scanning each of the scan lines, and a data driver supplying a display signal to each of the pixels. In synchronism with the scanning performed by the scan driver, a reset period, in which a charge accumulated in each of the light-emitting elements is discharged, is set, and control is performed so that a discharge termination timing in the reset period of the light-emitting elements connected to at least two of the scan lines is different regarding the scan lines which are not scanned in the subsequent scanning period.

According to a third aspect of the invention, in the third preferred constitution, a display device includes a display panel in which pixels including a capacitive light-emitting element are arranged at each intersection between a plurality of data lines and a plurality of scan lines, a scan driver connected to the scan lines and selectively scanning each of the scan lines, and a data driver supplying a display signal to each of the pixels. In synchronism with the scanning performed by the scan driver, a reset period, in which a charge accumulated in each of the light-emitting elements is discharged, is set, and control is performed so that a discharge start timing in the reset period of the light-emitting elements connected to at least two of the scan lines is different and so that a discharge termination timing in the reset period of the light-emitting elements connected to at least two of the scan lines is different regarding the scan lines which are not scanned in the subsequent scanning period.

A method for driving a display device according to the present invention for solving the above problem is characterized by including at least the features described below.

According to a tenth aspect of the invention, in the first preferred method for driving a display device, the display device includes a display panel in which pixels including a capacitive light-emitting element are arranged at each intersection between a plurality of data lines and a plurality of scan lines, a scan driver connected to the scan lines and selectively scanning each of the scan lines, and a data driver supplying a display signal to each of the pixels. In this method, a reset period, in which a charge accumulated in each of the light-emitting elements is discharged, is set in synchronism with the scanning performed by the scan driver, and control is performed so that a discharge start timing in the reset period of the light-emitting elements connected to at least two of the scan lines is different.

According to an eleventh aspect of the invention, in the second preferred driving method, the display device includes a display panel in which pixels including a capacitive light-emitting element are arranged at each intersection between a plurality of data lines and a plurality of scan lines, a scan driver connected to the scan lines and selectively scanning each of the scan lines, and a data driver supplying a display signal to each of the pixels. In this method, a reset period, in which a charge accumulated in each of the light-emitting elements is discharged, is set in synchronism with the scanning performed by the scan driver, and control is performed so that a discharge termination timing in the reset period of the light-emitting elements connected to at least two of the scan lines is different regarding the scan lines which are not scanned in the subsequent scanning period.

According to a twelfth aspect of the invention, in the third preferred driving method, the display device includes a display panel in which pixels including a capacitive light-emitting element are arranged at each intersection between a plurality of data lines and a plurality of scan lines, a scan driver connected to the scan lines and selectively scanning each of the scan lines, and a data driver supplying a display signal to each of the pixels. In this method, a reset period, in which a charge accumulated in each of the light-emitting elements is discharged, is set in synchronism with the scanning performed by the scan driver, and control is performed so that a discharge start timing in the reset period of the light-emitting elements connected to at least two of the scan lines is different and so that a discharge termination timing in the reset period of the light-emitting elements connected to at least two of the scan lines is different regarding the scan lines which are not scanned in the subsequent scanning period.

### BRIEF DESCRIPTION OF THE DRAWINGS

FIG. 1 is a circuit configuration diagram showing an example of the prior art display device;

FIG. 2 is an equivalent circuit diagram for explaining a reset operation performed in the display device of FIG. 1;

FIG. 3 is a timing chart for explaining a turned-on drive operation of the prior art display device including a reset period;

FIG. 4 is a timing chart for explaining another turned-on drive operation of the prior art display device including the reset period;

FIG. 5 is a block diagram showing a configuration example of a scan driver in a display device according to this invention;

FIG. 6 is a circuit configuration diagram showing an example of a scan switch in the scan driver;

FIG. 7 is a timing chart for explaining the operation of the scan driver of FIG. 5;

FIG. 8 is a timing chart for explaining the turned-on drive operation of the display device according to this invention;

FIG. 9 is a timing chart for explaining another example of the turned-on drive operation of the display device according to this invention; and

FIG. 10 is a timing chart for explaining a still another example of the turned-on drive operation of the display device according to this invention.

### DESCRIPTION OF THE REFERENCE NUMERALS

1 Display panel
2 Data driver
3 Scan driver
4 Light-emission control circuit
A1 to Am Data line (anode line)
E11 to Emn Light-emitting element (organic EL element)
I1 to Im Constant current source
K1 to Kn Scan line (Cathode line)
Sa1 to Sam Drive switch
Sk1 to Skn Scan switch
VH Drive voltage source
VM Reverse bias voltage source

### DESCRIPTION OF THE PREFERRED EMBODIMENTS

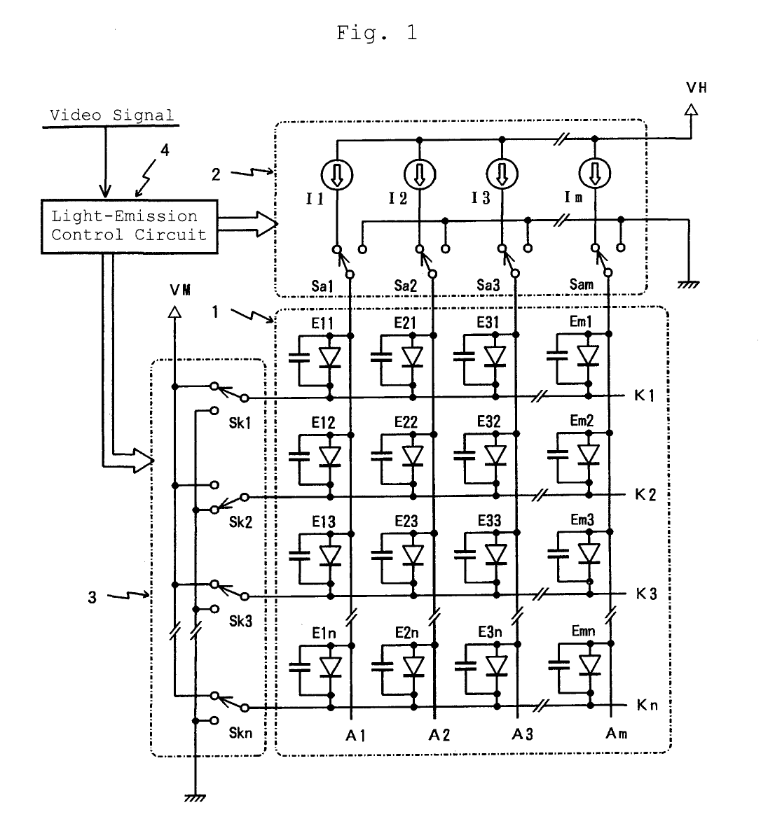

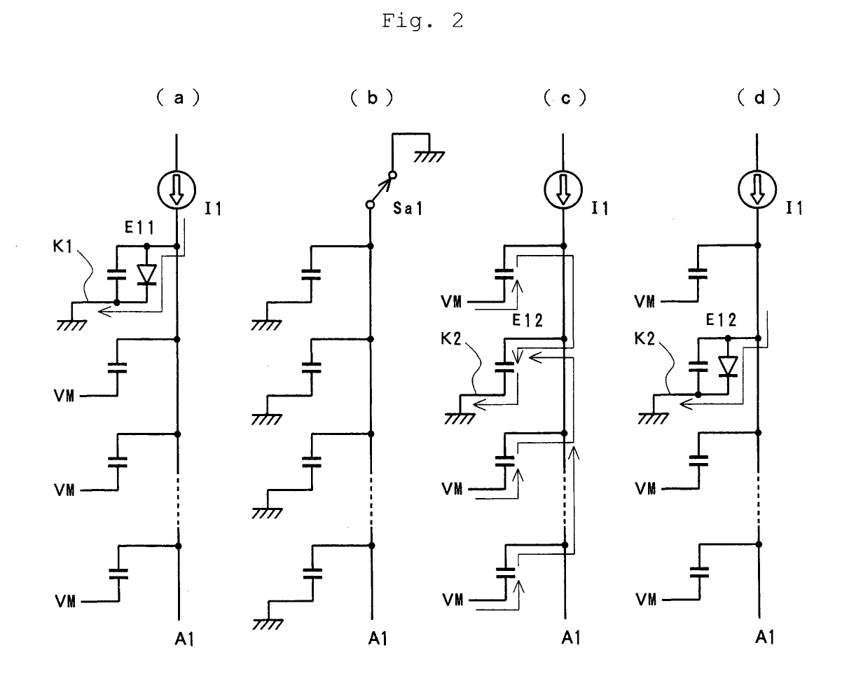

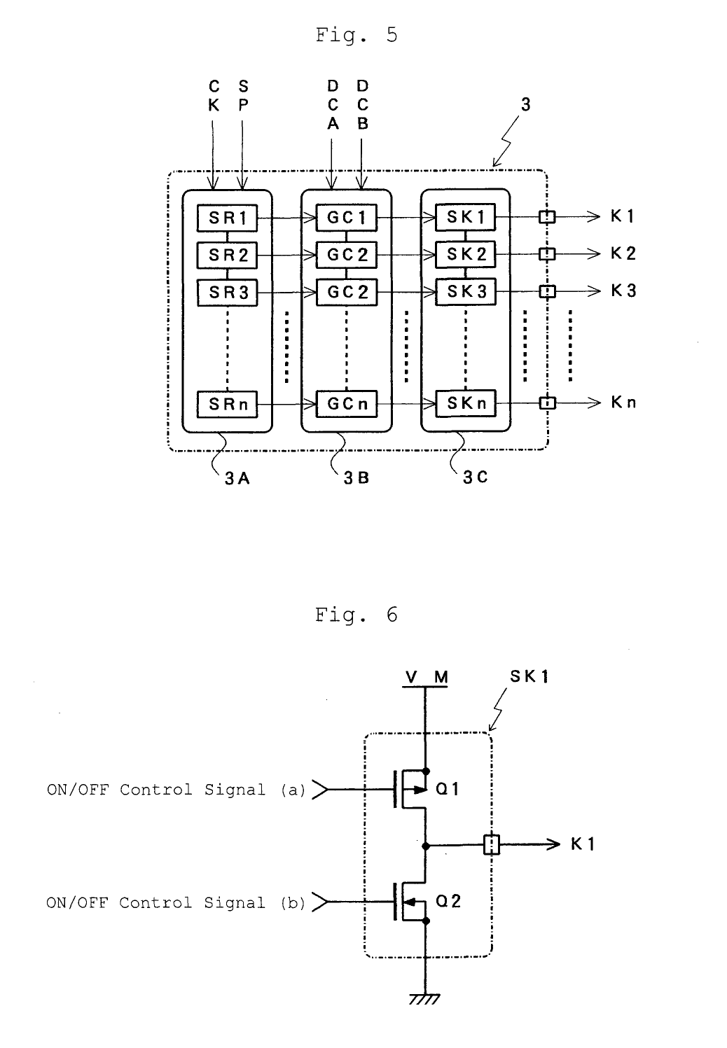

Hereinafter, a display device according to this invention and a method for driving the display device will be described based on the embodiment shown in the drawings. A basic configuration of the display device according to this invention is shown in FIG. 1 described above. In addition to this, in the embodiment according to this invention, a configuration of a scan driver shown in, for example, FIG. 5 is used.

Namely, FIG. 5 is a block diagram showing an example of a scan driver 3 adopted in this invention. The scan driver 3 includes a shift register group 3A for scanning in which shift resisters SR1 to SRn are connected in series. The scanning shift register group 3A is constituted so that a scan shift clock CK and a scan start pulse SP are supplied from the light-emission control circuit 4 shown in FIG. 1.

The shift register group 3A receives the scan shift clock CK and the scan start pulse SP to synchronize a scan synchronization signal, and, thus, to make the shift resistors SR1 to SRn sequentially generate the shift output. Namely, the shift register group 3A is operated so that the shift registers in which the shift output is generated are switched in sequence.

Meanwhile, an output control circuit 3B controls the discharge start timing and the discharge termination timing in the reset period by using the shift outputs from the shift resistors SR1 to SRn and includes gate circuits GC1 to GCn respectively receiving the shift outputs from the shift resistors SR1 to SRn. The output control circuit 3B is constituted to receive a discharge control signal A (DCA) and a discharge control signal B (DCB).

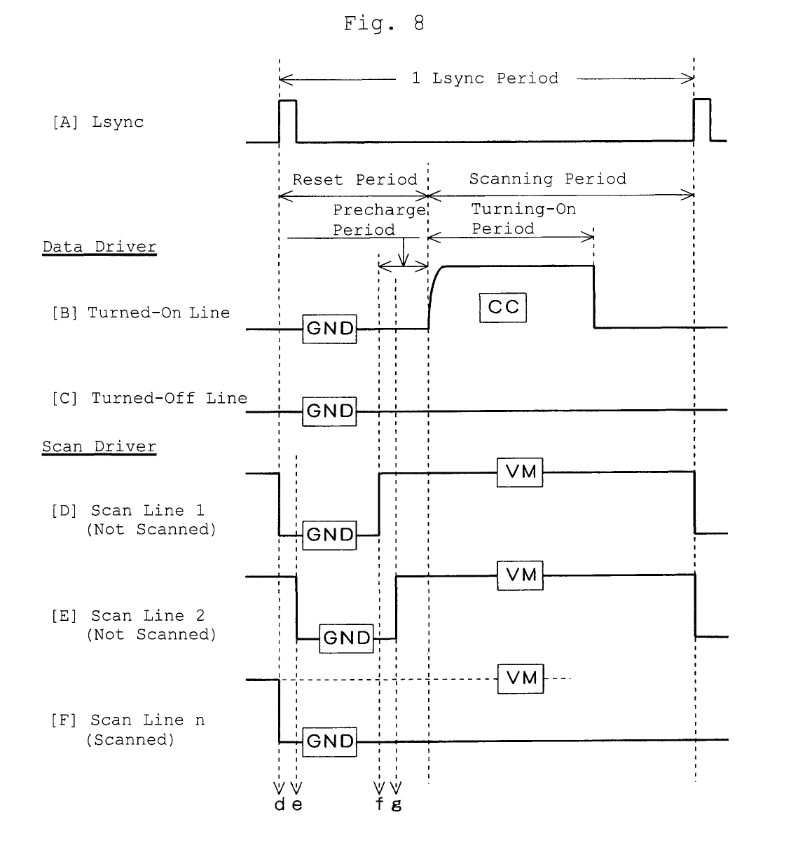

FIG. 7 is a timing chart for explaining the operation of the output control circuit 3B. The discharge control signal A (DCA) and the discharge control signal B (DCB), which are slightly phase-shifted, are supplied to the output control circuit 3B. In this embodiment, in synchronism with the DCA, the discharge start timing and the discharge termination timing of the odd-number-th scan lines (scan lines K1 and K3 of FIG. 7) are set. Further, the output control circuit 3B operates so that in synchronism with the DCB, the discharge start timing and the discharge termination timing of the even-number-th scan lines (scan lines K2 and K4 of FIG. 7) are set.

FIG. 7 shows an example of a control output signal corresponding to each of the scan lines K1 to K4; however, also in the scan line K5 to the successive scan lines, the discharge start timing and the discharge termination timing are set in synchronism with the DCA and DCB in accordance with the odd-number-th and even-number-th scan lines.

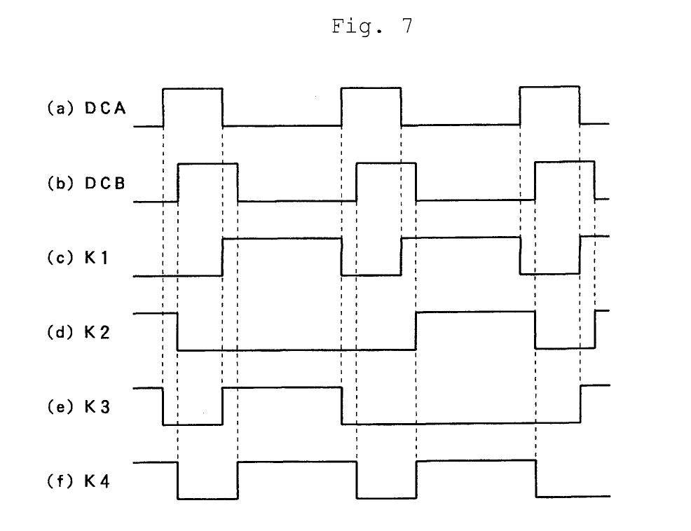

The control output signals represented by K1 to K4 of FIG. 7 are supplied to a scan switch group 3C shown in FIG. 5. Although FIG. 6 shows a configuration example of the scan switch SK1 in the scan switch group 3C, the scan switches SK2 to SKn have the same configuration.

The scan switch SK1 shown in FIG. 6 is, for example, a p-type MOSFET (Q1) as a first analog switch, and the reverse bias voltage VM is supplied to a source of the FET. A drain of the FET (Q1) is connected to the first scan line K1, and therefore, an ON/OFF control signal (a) is supplied to the gate, whereby the reverse bias voltage VM can be selectively supplied to the first scan line K1.

Meanwhile, an n-type MOSFET (Q2) is used as a second analog switch, and a source of the FET is connected to the scan selection potential (ground potential GND) described above. The FET (Q2) drain is connected to the first scan line K1, and therefore, an ON/OFF control signal (b) is supplied to the gate, whereby the first scan line K1 can be selectively set to the scan selection potential.

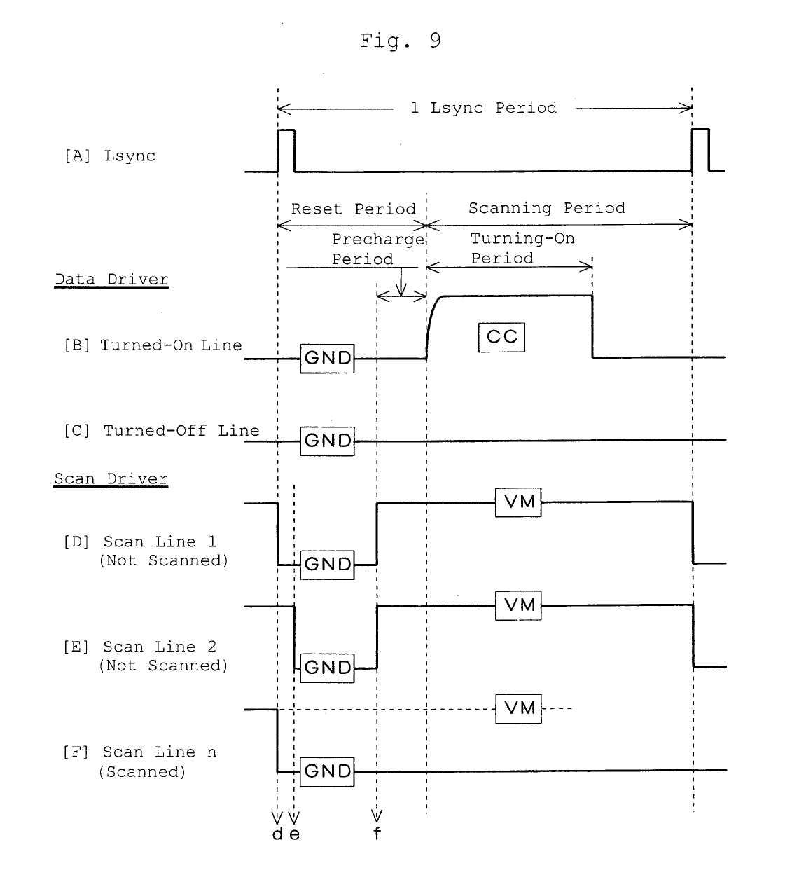

Thus, the control output signals represented by K1 to K4 of FIG. 7 are supplied as the ON/OFF control signals (a) and (b) to the scan switches with the configuration shown in FIG. 6. Consequently, as shown in FIG. 8, control is performed so that the discharge start timing and the discharge termination timing in the reset period are different for each of the odd-number-th and even-number-th scan lines.

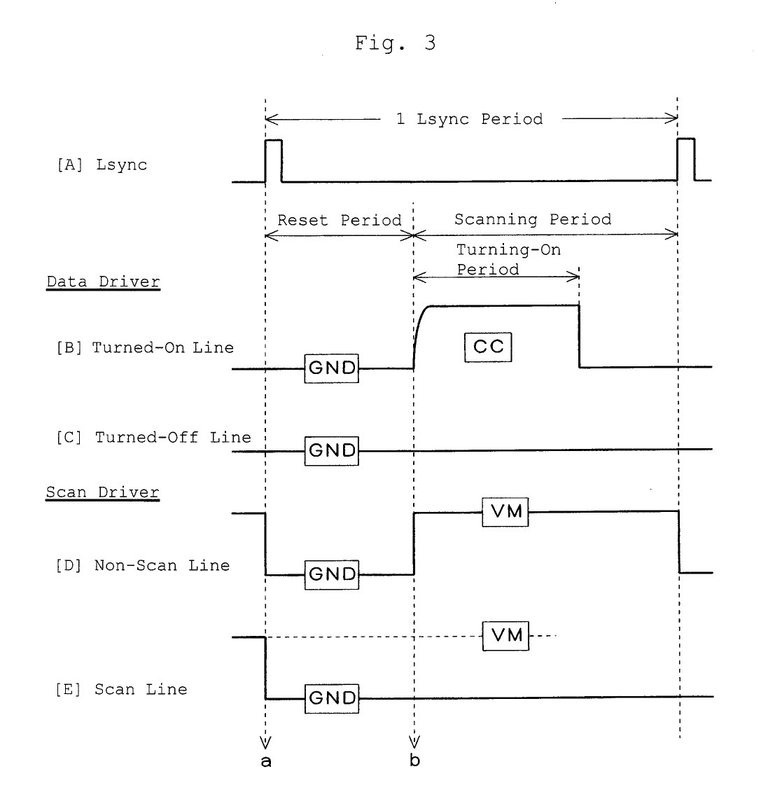

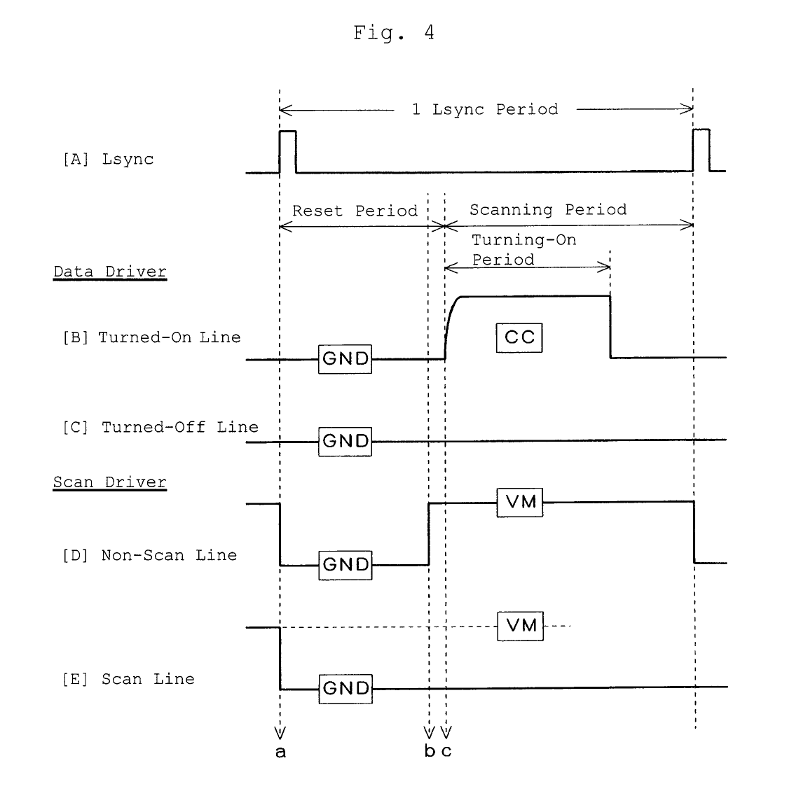

FIG. 8A to 8C are similar to FIGS. 3 and 4 described above, and thus the detailed description is omitted. FIG. 8F shows an example in which the n-th scan line (“scan line” in FIG. 8F) is scanned. In this case, the application state of the voltage on a scan line 1 representing the odd-number-th scan line, which is not scanned, is represented in FIG. 8D, and the application state of the voltage on a scan line 2 representing the even-number-th scan line, which is not scanned, is represented in FIG. 8E.

As shown in FIG. 8, in this embodiment, control is performed so that in the arrangement order of the scan lines arranged on the display panel, the discharge start timing (d and e of FIG. 8) and the discharge termination timing (f and g of FIG. 8) in the reset period are different between the EL elements connected to the odd-number-th scan lines and the EL elements connected to the even-number-th scan lines.

According to the above constitution, the discharge start timing in the reset period is dispersed in two as shown as d and e of FIG. 8, and thus the level of the radiation noise generated at this time can be reduced. The discharge termination timing in the reset period is also dispersed in two as shown as f and g of FIG. 8, and thus the level of the radiation noise generated at this time can be reduced.

The discharge termination timing in the reset period is dispersed as shown as f and g, and therefore, a value of the current for charging flowing through the scan lines, which are not scanned, can be reduced by the reverse bias voltage source VM, whereby the deterioration of the display quality caused by the variation of the power supply voltage can be reduced.

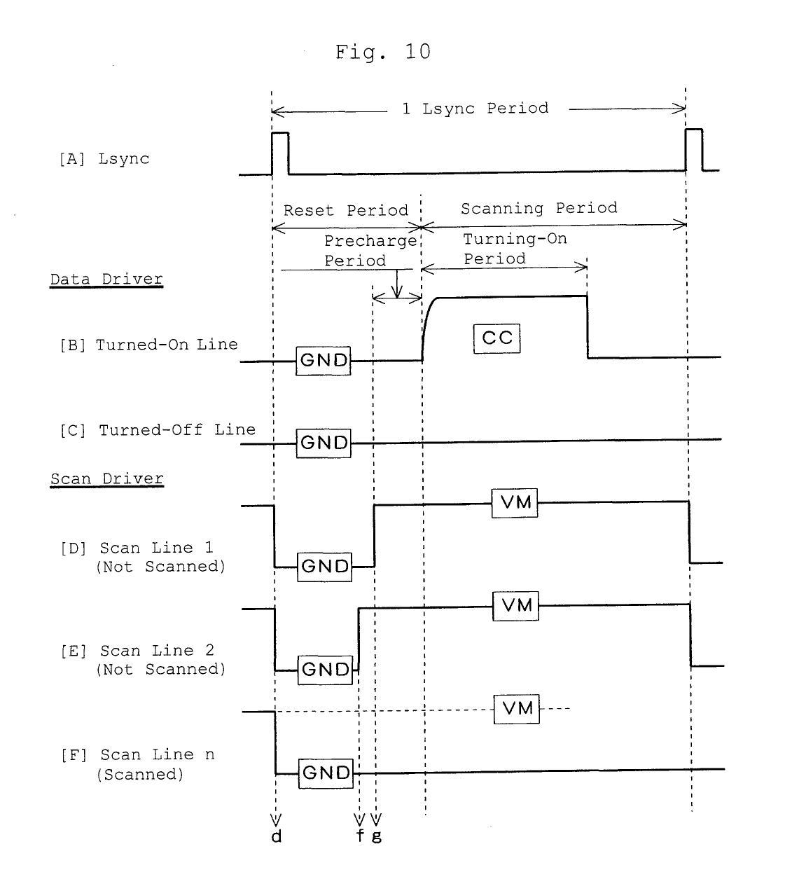

FIG. 9 shows an example in which control is performed so that the discharge start timing in the reset period is different between the EL elements connected to the odd-number-th scan lines and the EL elements connected to the even-number-th scan lines. FIGS. 9A to 9F are similar to the example shown in FIG. 8, and thus the detailed description is omitted.

Also in the example shown in FIG. 9, control is performed so that the discharge start timing is different between the EL element connected to the odd-number-th scan lines and the EL elements connected to the even-number-th scan lines, as shown as d and e of FIG. 9, whereby the effect of the reduction of the radiation noise level can be expected.

FIG. 10 shows an example in which control is performed so that the discharge termination timing in the reset period is different between the EL elements connected to the odd-number-th scan lines and the EL elements connected to the even-number-th scan lines. FIGS. 10A to 10F are similar to the example shown in FIG. 8, and thus the detailed description is omitted.

Also in the example shown in FIG. 10, control is performed so that the discharge termination timing is different between the EL element connected to the odd-number-th scan lines and the EL elements connected to the even-number-th scan lines, as shown as f and g of FIG. 10, whereby the effect of the reduction of the radiation noise level can be expected. Further, in the example shown in FIG. 10, the discharge termination timing is dispersed, whereby the value of the current for charging flowing through the scan lines, which are not scanned, can be controlled, and the deterioration of the display quality caused by the variation of the power supply voltage can be reduced.

In the above embodiment, control is performed so that the discharge start timing and/or the discharge termination timing in the reset period is/are different between the EL elements connected to the odd-number-th scan lines and the EL elements connected to the even-number-th scan lines; however, this is not limited to the odd-number-th and even-number-th scan lines, and the control is performed in at least two scan lines, whereby the effect of the reduction of the radiation noise level can be obtained.

Further, even if control is performed so that a plurality of scan lines are divided into the former half group and the latter half group, and the discharge start timing and/or the discharge termination timing is/are different between the former half group and the latter half group, a similar effect can be obtained.

Further, control is performed so that the discharge start timing and/or the discharge termination timing is/are different for each scan line, whereby the effect of the reduction of the radiation noise level can be further expected.

In the above embodiment, the organic EL elements are used as light-emitting elements arranged on the display panel; however, this invention can be applied to a display device using another display panel including a capacitive light-emitting element having a diode characteristic, and a similar operational effect can be obtained.

What is claimed is:

1. A display device comprising:
a display panel in which pixels including a capacitive light-emitting element are arranged at each intersection between a plurality of data lines and a plurality of scan lines;
a scan driver connected to the scan lines and selectively scanning each of the scan lines; and
a data driver supplying a display signal to each of the pixels,
wherein a reset period, in which a charge accumulated in each of the light-emitting elements is discharged, is set in synchronism with the scanning performed by the scan driver, and control is performed so that a discharge start timing in the reset period of the light-emitting elements connected to at least two of the scan lines is different.

2. A display device comprising:
a display panel in which pixels including a capacitive light-emitting element are arranged at each intersection between a plurality of data lines and a plurality of scan lines;
a scan driver connected to the scan lines and selectively scanning each of the scan lines; and
a data driver supplying a display signal to each of the pixels,
wherein a reset period, in which a charge accumulated in each of the light-emitting elements is discharged, is set in synchronism with the scanning performed by the scan driver, and control is performed so that a discharge termination timing in the reset period of the light-emitting elements connected to at least two of the scan lines is different regarding the scan lines which are not scanned in the subsequent scanning period.

3. A display device comprising:
a display panel in which pixels including a capacitive light-emitting element are arranged at each intersection between a plurality of data lines and a plurality of scan lines;
a scan driver connected to the scan lines and selectively scanning each of the scan lines; and
a data driver supplying a display signal to each of the pixels,
wherein a reset period, in which a charge accumulated in each of the light-emitting elements is discharged, is set in synchronism with the scanning performed by the scan driver, and control is performed so that a discharge start timing in the reset period of the light-emitting elements connected to at least two of the scan lines is different and so that a discharge termination timing in the reset period of the light-emitting elements connected to at least two of the scan lines is different regarding the scan lines which are not scanned in the subsequent scanning period.

4. The display device as claimed in claim 1, wherein control is performed so that in the arrangement order of the scan lines arranged on the display panel, the discharge start timing in the reset period is different between the light-emitting element connected to the odd-number-th scan line and the light-emitting element connected to the even-number-th scan line.

5. The display device as claimed in claim 2, wherein control is performed so that in the arrangement order of the scan lines arranged on the display panel, the discharge termination timing in the reset period is different between the light-emitting element connected to the odd-number-th scan line and the light-emitting element connected to the even-number-th scan line.

6. The display device as claimed in claim 3, wherein control is performed so that in the arrangement order of the scan lines arranged on the display panel, the discharge start timing in the reset period is different between the light-emitting element connected to the odd-number-th scan line and the light-emitting element connected to the even-number-th scan line, and so that the discharge termination timing in the reset period is different between the light-emitting element connected to the odd-number-th scan line and the light-emitting element connected to the even-number-th scan line.

7. The display device as claimed in claim 1, wherein control is performed so that the discharge start timing in the reset period of each of the light-emitting elements, which are connected to all the scan lines arranged on the display panel, is different for each of the scan lines.

8. The display device as claimed in claim 2, wherein control is performed so that the discharge termination timing in the reset period of each of the light-emitting elements, which are connected to all the scan lines arranged on the display panel, is different for each of the scan lines.

9. The display device as claimed in claim 3, wherein control is performed so that the discharge start timing and the discharge termination timing in the reset period of each of the light-emitting elements, which are connected to all the scan lines arranged on the display panel, are different for each of the scan lines.

10. A method for driving a display device, which includes a display panel in which pixels including a capacitive light-emitting element are arranged at each intersection between a plurality of data lines and a plurality of scan lines, a scan driver connected to the scan lines and selectively scanning each of the scan lines, and a data driver supplying a display signal to each of the pixels, comprising:
setting a reset period, in which a charge accumulated in each of the light-emitting elements is discharged, in synchronism with the scanning performed by the scan driver; and
controlling so that a discharge start timing in the reset period of the light-emitting elements connected to at least two of the scan lines is different.

11. A method for driving a display device, which includes a display panel in which pixels including a capacitive light-emitting element are arranged at each intersection between a plurality of data lines and a plurality of scan lines, a scan driver connected to the scan lines and selectively scanning each of the scan lines, and a data driver supplying a display signal to each of the pixels, comprising:
setting a reset period, in which a charge accumulated in each of the light-emitting elements is discharged, in synchronism with the scanning performed by the scan driver; and
controlling so that a discharge termination timing in the reset period of the light-emitting elements connected to at least two of the scan lines is different regarding the scan lines which are not scanned in the subsequent scanning period.

12. A method for driving a display device, which includes a display panel in which pixels including a capacitive light-emitting element are arranged at each intersection between a plurality of data lines and a plurality of scan lines, a scan driver connected to the scan lines and selectively scanning each of the scan lines, and a data driver supplying a display signal to each of the pixels, comprising:
setting a reset period, in which a charge accumulated in each of the light-emitting elements is discharged, in synchronism with the scanning performed by the scan driver; and
controlling so that a discharge start timing in the reset period of the light-emitting elements connected to at least two of the scan lines is different and so that a discharge termination timing in the reset period of the light-emitting elements connected to at least two of the scan lines is different regarding the scan lines which are not scanned in the subsequent scanning period.
